(19) United States
(12) Patent Application Publication
(10) Pub. No.: US 2008/0159274 A1
(43) Pub. Date: Jul. 3, 2008

(54) Method and apparatus for improved routing necessitated by network element replacement

(76) Inventors: David L. Brugman, San Clemente, CA (US); Michael D. DeRousse, Red Bud, IL (US)

Correspondence Address: FAY SHARPE/LUCENT, 1100 SUPERIOR AVE, SEVENTH FLOOR, CLEVELAND, OH, 44114, US

(21) Appl. No.: 11/729,223

(22) Filed: Mar. 28, 2007

Related U.S. Application Data
(63) Continuation-in-part of application No. 11/648,465, filed on Dec. 29, 2006.
Application No. 11/648,465 is a continuation-in-part of application No. 11/648,256, filed on Dec. 29, 2006.

(51) Int. Cl. H04L 12/66

(52) U.S. Cl. 370/356

(57) ABSTRACT

A method and apparatus for improved routing necessitated by network element replacement are provided. The contemplated system and technique control routing updates on a variety of systems, including target and legacy systems, during switch replacement on the public switched telephone network (PSTN). The routing changes are coordinated between multiple network elements. In one form, the invention mechanizes the required changes for this action in all network elements sequentially.

This application is a continuation-in-part of U.S. patent application Ser. No. 11/648,465, filed Dec. 29, 2006, entitled “A Method and Apparatus for Facilitating Migration from an Analog Network to a Voice Over Internet Protocol Network,” to Brugman and a continuation-in-part of U.S. patent application Ser. No. 11/648,256, filed Dec. 29, 2006, entitled “A Method and Apparatus for Improved Analog Line Migration to Accommodate Customer Premise Equipment Changes,” to Brugman et al.

### RELATED APPLICATIONS

This application is related to U.S. patent application Ser. No. 11/648,465, filed Dec. 29, 2006, entitled “A Method and Apparatus for Facilitating Migration from an Analog Network to a Voice Over Internet Protocol Network,” to Brugman, and U.S. patent application Ser. No. 11/648,256, filed Dec. 29, 2006, entitled “A Method and Apparatus for Improved Analog Line Migration to Accommodate Customer Premise Equipment Changes,” to Brugman et al., both of which are incorporated herein by reference.

### BACKGROUND

This invention relates to a method and apparatus for improved routing necessitated by network element replacement. The contemplated system and technique control routing updates on a variety of systems, including target and legacy systems, during switch replacement on the public switched telephone network (PSTN). The routing changes are coordinated between multiple network elements. In one form, the invention mechanizes the required changes for this action in all network elements sequentially.

While the invention is particularly directed to the art of improved routing techniques, and will be thus described with specific examples, it will be appreciated that the invention may have usefulness in other fields and applications. For example, the invention may be used in a variety of circumstances where migration of routes requires coordination among network elements.

Presently, when route changes are necessary during switch replacement, the changes are typically coordinated manually and performed by several work groups. Typically, four separate activities are required. This is accomplished, for example, through timed activity or conference calls. Also, under some current routing change scenarios, it is common to place constructed dual routes, with the existing route being active and the new route being standby. During the routing change process, the existing route is deactivated and the new route is activated. This, however, requires that additional hardware be provided to each network element.

There are other difficulties with current technology. In this regard, when switching changes are implemented, software reprogramming for each route in a network that includes Class 4 and/or Class 5 switching platforms is oftentimes necessary. Although such routing migrations are possible to achieve manually by coordinating concurrent changes in several work groups to reprogram each network element, the time the route under transition is out of service time can become lengthy. Thus, present methods do not allow low risk, low cost route-by-route changes in coordination with the contemplated network facility rearrangements.

The present invention contemplates a new and improved system and technique that resolves the above-referenced difficulties and others.

### SUMMARY OF THE INVENTION

A method and apparatus for network element replacement routing are provided.

In one aspect of the invention, a system for controlling routing changes during a switch replacement in a network comprises a first switching element, a second switching element, a secured access link connected to the first switching element and the second switching element and a routing migration broker connected to the secured access link, the routing migration broker being operative to receive instructions on routing changes, the routing changes being associated with a replacement of the first switching element by a second switching element, implement the routing changes and reporting a status of the routing changes.

In another aspect of the invention, the first and second switching elements are of a Class 4 type.

In another aspect of the invention, the first and second switching elements are of a Class 5 type.

In another aspect of the invention, the first switching element is a Time Division Multiplexed (TDM) based end office and the second switching element is an Internet Protocol (IP) based end office.

In another aspect of the invention, the first switching element is a Time Division Multiplexed (TDM) based tandem switch and the second switching element is an Internet Protocol (IP) based tandem switch.

In another aspect of the invention, the first and second switching elements are Time Division Multiplexed (TDM) based switching elements.

In another aspect of the invention, the migration broker is operative to communicate with the first and second switching elements through the secured access link.

In another aspect of the invention, a method for route changing during a switch replacement in a network comprises receiving a request at a migration broker to migrate routes from a first switching element to a second switching element in the network, validating the request, and, implementing routing changes by the migration broker in accordance with the request, the routing changes effecting a replacement of the first switching element by the second switching element.

In another aspect of the invention, validating the request comprises verifying a work order.

In another aspect of the invention, the first and second switching elements are of a Class 4 type.

In another aspect of the invention, the first and second switching elements are of a Class 5 type.

In another aspect of the invention, the first switching element is a Time Division Multiplexed (TDM) based end office and the second switching element is an Internet Protocol (IP) based end office.

In another aspect of the invention, the first switching element is a Time Division Multiplexed (TDM) based tandem switch and the second switching element is an Internet Protocol (IP) based tandem switch.

In another aspect of the invention, the first and second switching elements are Time Division Multiplexed (TDM) based switching elements.

In another aspect of the invention, the migration broker is operative to communicate with the first and second switching elements through the secured access link.

In another aspect of the invention, means are provided to implement the method.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a representative block diagram of a network into which the presently described embodiments may be incorporated.

FIG. 2 is a representative block diagram of a network into which the presently described embodiments are incorporated.

FIG. 3 is a representative block diagram of a network into which the presently described embodiments may be incorporated.

FIG. 4 is a representative block diagram of a network into which the presently described embodiments are incorporated.

FIG. 5 is a flowchart illustrating a method according to the presently described embodiments.

### DETAILED DESCRIPTION

The presently described embodiments of the invention correlate software tools needed to migrate or move routes between similar or dissimilarly programmed network platforms. The system “brokers” software change requests into specific network element inputs and retrievals that are required to evolve the routing software to the new configuration. All of the telecommunications provisioning capabilities, network access capabilities, software mapping and software back out tools are centralized at one control point, e.g. a Routing Migration Broker that can, in one form, be a serving computer such as a personal computer (PC).

By placing control at a single point in the manners contemplated herein, the time it takes to affect changes is greatly reduced. All work operations (e.g. software changes) are programmed to occur sequentially. This mechanization results in a more efficient use of time allowed. The risk is reduced because the point of control monitors all actions visually in real time, rather than through voice communications. There is positive assurance software changes will be done in the correct order.

There is also a significant cost savings with implementation of the presently described embodiments. In this regard, for example, switch ports can be saved because route segments can be reused rather than replaced.

Thus, the presently described embodiments result in a mechanized activation of the typically massive routing updates that are required during switch replacement on the Public Switched Telephone Network (PSTN). All software changes are accomplished sequentially across multiple network elements for routing changes on the Public Switched Telephone Network and are accomplished in coordination with switching element replacement.

In operation, the routing change requests are initiated by an end user by connecting to a Routing Migration Broker through a suitable interface such as a web browser. Activation or deactivation software changes may then be performed on network elements. However, for security and efficiency reasons, the software changes may only be made after the end user inputs a work order number associated with the route to be changed. The work order number operates as a key to a work list that resides on the Routing Migration Broker. If the work order number is not on the Routing Migration Broker work list, the end user will be notified, e.g. via the access web portal, and connection to the network element provisioning channels will not be attempted.

Optionally, concurrent action can be triggered to transmit information that can be used to synchronize support system databases as each work order is completed.

It should be appreciated that the presently described embodiments may take a variety of forms that will be described hereafter and result in a variety of benefits. Nonetheless, at least some benefits of the contemplated method and apparatus include:

1. A resultant routing migration process that places all related work activities under a single end user's control;

2. A method that reduces risk by assuring proper synchronization of all software change activity;

3. Flexibility in terms of the times at which conversions can be initiated (e.g. the route can be converted in real time at any time of the day—the only requirement being that an alternate route must be available during the migration period);

4. Reverse routing migrations, if necessary and requested;

5. Delivery of electronic progress reports to the administrators;

6. Enhanced security through centralized control and other limitations that can be placed on the routing migration request; and,

7. Accomplishment of migration over time so the dangers of flash cutovers can be obviated.

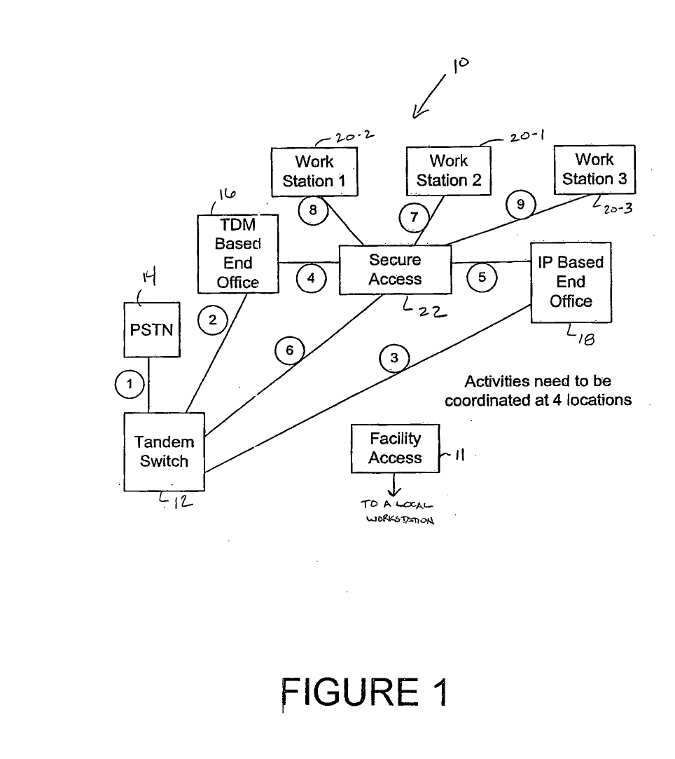

Referring now to the drawings wherein the showings are for purposes of illustrating the exemplary embodiments only and not for purposes of limiting the claimed subject matter, FIG. 1 provides a view of a system 10 into which the presently described embodiments may be incorporated. As shown generally, FIG. 1 depicts current routing migration methods performed on the network 10 when a switch 16, e.g. a Class 5 TDM based and office switch, is replaced. Link 1 represents all connections from the PSTN 14 to a tandem switch 12 (e.g. a class 4 switch), with the exception of the switches under migration. Link 2 represents the existing route to a time division multiplexed (TDM) based end office 16, the switch that will be replaced. The route that will be deactivated is represented by link 2. Link 3 represents the new route to, for example, a TCP/IP based end office 18 (e.g. another class 5 switch), the replacement switch. The route that will be activated to the replacement network switch 18 is represented by link 3. Link 4 represents a connection to a centralized secure access link that telephone companies normally use to communicate with switch provisioning recent change channels. This link provides communication with the existing switch 16.

A centralized secure access link that telephone companies normally use to communicate with switch provisioning recent change channels is represented by the box 22 labeled Secure Access. Link 5 represents a connection to the centralized secure access link 22 for the replacement switch 18. Link 6 represents a connection to the centralized secure access link 22 for the Class 4 switch 12.

Link 7 represents the communication link from a software translation workstation 20-1 that is used to deliver software changes to the Class 4 switch 12 through link 6. Link 8 represents the communication link for software translation workstation 20-2 that is used to deliver software changes to the existing switch 16 through link 4. Link 9 represents the communication link for software translation workstation 20-3 that is used to deliver software changes to the replacement switch 18 through link 5. Reference numeral 11 represents access to facilities that can be rerouted via software changes. As shown, the facilities access may be had through local work stations that may or may not be connected through the secure access 22.

It should be appreciated that FIG. 1 represents the provisioning configuration before a Routing Migration Broker contemplated by the presently described embodiments is placed into service. So, at the moment of routing change in this environment, work activities need to take place sequentially in all three switches. It is also common in the industry to re-home the facilities on links 2 and 3 by issuing changes to digital cross connect frames. This process is represented by element 10. The sequence of events is unique to each network element and unless all tasks are completed correctly, and in the right sequence, the routing change will fail.

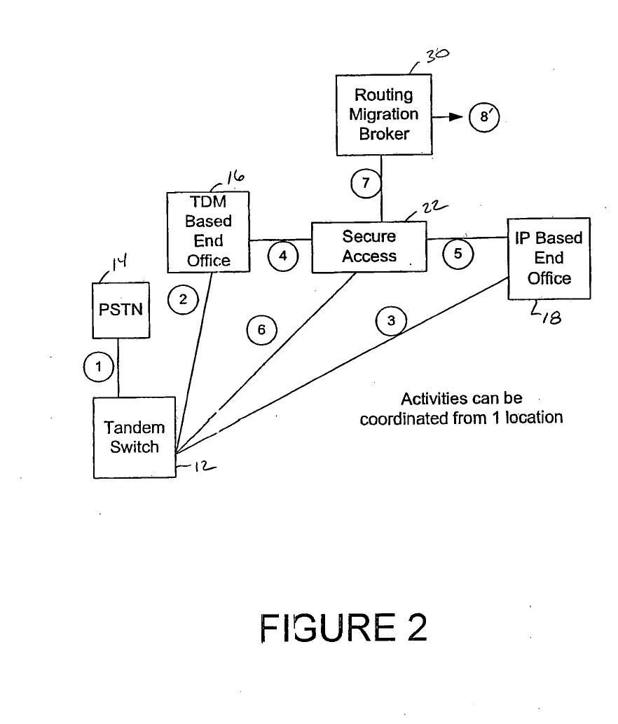

FIG. 2 outlines a corresponding process of switch replacement using a Routing Migration Broker 30 according to the presently described embodiments. The Routing Migration Broker 30 controls all software change activity.

More particularly, FIG. 2 depicts the placement of the Routing Migration Broker 30 during the Routing Migration period when a switch is replaced. It should be understood that the Routing Migration Broker 30 only needs to be active in the network during the customer defined transition period. It does not need to be a permanent network element-provisioning vehicle. However, it should also be appreciated that the Broker 30 may take a variety of forms. It may be implemented using various software techniques and/or different hardware configurations. For example, the Broker 30 may be implemented as a software routine that primarily resides on the switching element or distributed on the network. As noted above, it may also reside on a serving computer such as a PC-type computer.

In one form, a serving computer is used as a Routing Migration Broker 30 and is placed on an internal network segment of a service provider that has access to the associated network element provisioning channels. The Routing Migration Broker 30 is accessed through standard web browser connectivity. In operation, a work order is accessed. The work order is first verified for validity and all changes therein are delivered to the proper network elements in the correct order. The Routing Migration Broker issues and monitors the network element software changes and provides real-time status updates.

The software tools on the Routing Migration Broker may take a variety of forms, but in one form, include a Web server, an SQL database, programming languages to communicate with network elements using text interfaces, the TCP/IP communications utilities and custom Shell, Perl, AWK, PHP, SQL and Tool Control Language Expect scripts.

The Web server provides the user interface for the work order requests and report outputs. This type of activity was previously accomplished through direct access to the switch and per route change inputs. This activity is now done through a simple Web browser.

Use of, and extremely restricted access to, the SQL database provides the connection security typical users require. It also maintains in a secure fashion all of the software messaging that will be delivered to the switches. It is also used to track all access and store delivery benchmarks. The database is also used to generate activity reports when the user requests them.

The software scripts mechanize access security, software change message generation, communications for data collection and software change message delivery, SQL database administration and user report generation. Previously, this work was typically done using several provisioning support systems.

Referring back now to FIG. 2, Link 1 represents all PSTN routes to the switch 12 with the exception of the switches under migration. Link 2 represents the existing route to the TDM based end office 16, the switch that will be replaced. Link 3 represents the new route to the TCP/IP based end office 18, the replacement switch. Link 4 represents a connection to the centralized secure access link 22 for the existing switch 16. Link 5 represents a connection to the centralized secure access link 22 for the replacement switch 18. Link 6 represents a connection to the centralized secure access link 22 for the Class 4 switch 12.

Link 7 represents the Routing Migration Broker communication link performing all actions previously performed via links 7, 8, and 9 (and Facility Access 11, where applicable) in FIG. 1. Link 8′ represents connection to support system database update mechanisms. This link be informational or a TCP/IP port that can deliver the information through electronic processes such as email or File Transfer Protocol.

Note that Links 7, 8, and 9, (and Facility Access 11, where applicable) in FIG. 1 are replaced with link 7 in FIG. 2. By placing all software change activity under a single point of control, correct synchronization of all activity is now assured. This is accomplished by mechanizing all of the activity previously done in up to 4 locations, sequencing it correctly and then placing it on the Broker for end user activation, change observation and administrative control.

The automation contemplated herein may be implemented in software and take a variety of forms as a factor of the operating system, programming language, and the like. However, in at least one form, the software accommodates a change of messaging for new route configurations that are unique to the switch type and new route functionality requirements. The change messages are constructed based on current route software equipage and the user's predefined replacement route feature needs. Software messaging to restore the original functionality is also prepared so that the user can reverse the migration in order to restore service in case difficulties are encountered, for example, a non-working replacement route.

In operation, a person administering the Routing Migration Broker 30 typically establishes a work order list that is placed on the Routing Migration Broker 30 before any migrations are initiated. This may be accomplished using a variety of software techniques. The task list may take a variety of forms and configurations. However, in one form, the task list comprises the tasks of rendering trunks busy in all switches, applying routing changes, swinging facilities, diagnosing trunks, returning new routes to service, and preparing records updates.

The actual migration begins by establishing web portal access for the Routing Migration Broker 30 across link 7. The end user inputs a work order number using the web portal and requests migration by clicking on an appropriate Web page event (link 7).

If the work order number input by the end user matches an item on the work list, the provisioning channel is accessed through the Secure Access Link 22. The Migration Broker checks the migration state on the route and if the state is pre-migration, the broker verifies the routing software, computes the migration forward and rollback messaging, and sends the changes to the appropriate switch using a native protocol. It should be appreciated that the computing of messaging regarding the changes involves a number of functions including generating provisioning orders. For example, the switch is queried by the Routing Migration Broker to obtain a text dump of information on the features that are available on the route and the port assignments. A Perl script (prepared by the user using appropriate mapping information) is run on the text to replace features in the text, based on the mapping information. By modifying the text, the switch will be able to understand the changes when it receives them. So, once the changes are received by the switch, the route is evolved to its migrated state.

Provisioning orders for configuration changes are also prepared in real time using the routing mapping tools on the Routing Migration Broker 30. In this regard, the configuration changes are constructed based on current software equipage, switch port assignment, and the replacement feature functionality. The current routing equipage is collected and analyzed as an integral part of the process. Scripts for this data collection are stored by switch type and are associated with the switch under migration in the internal Broker database. Also, the route mapping tools typically take the form of custom scripts based on the user's needs that are placed on the Broker. The mapping requirements are documented in a text file and Perl and AWK scripts are constructed to build and store the software change messages required for migration and rollback. Appropriate software changes are then delivered to the switch and monitored by the Broker 30 (as described above). These software changes include specific software messaging and the appropriate protocols to administer message specific provisioning channel conversations on a per change basis. As the changes are sent to the switch all expected switch provisioning channel responses are accounted for and answered without user intervention.

Once the switch notifies the Broker that the requested software changes have been completed, the activity is logged in the Broker database and the user is notified. This process continues until all routes scheduled for the session have been migrated. When the user is ready to log off, he/she requests a Broker to provisioning channel disconnect. After the disconnect is complete, the user is notified and is free to either generate reports or disconnect from the web page. If the user disconnects from the browser without disconnecting the Broker to the provisioning channel connection, the Broker will automatically disconnect the channel in the users defined default period.

A rollback provisioning order for the switch is also prepared and stored for future use in real time. Typically, a rollback provisioning order includes all software routing that was associated with a specific route before any migration is requested. The rollback provisioning order is constructed in a way that allows changes to be applied to the route in the migrated state. A rollback order cannot be applied to a route unless it has been previously migrated. Current migration status is stored in the work list.

At session completion, in one form of the invention, statistics will be updated on the Routing Migration Broker 30 and will be displayed to the end user. Statistics will also be logged for each step in this process. The end user can now migrate the next route.

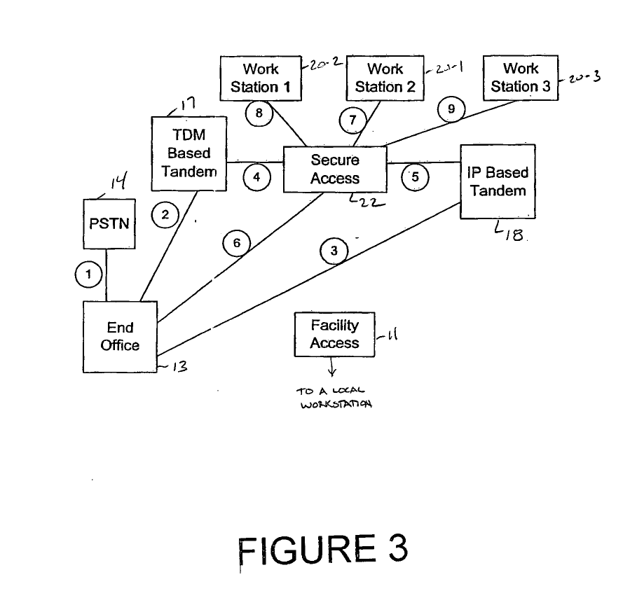

With reference to FIG. 3, it should be appreciated that the configuration shown has the same functionality as the configuration of FIG. 1, with the exception of destination switch role reversals. In this regard, in FIG. 3, a Class 4 switch is being replaced, and in FIG. 1, a Class 5 switch is being replaced.

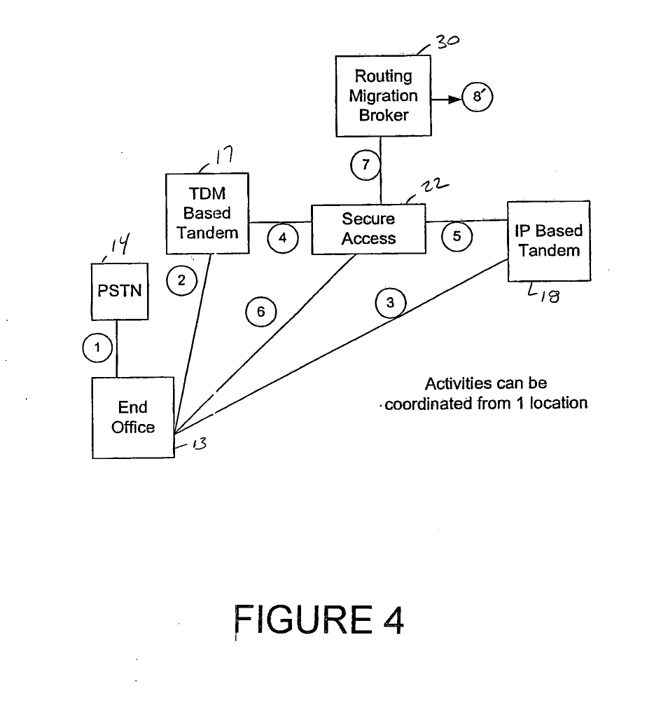

Likewise, with reference to FIG. 4, the configuration shown has the same functionality as the configuration shown in FIG. 2, with the exception of destination switch role reversals. In this regard, in FIG. 4, a Class 4 switch 17 is being replaced, and in FIG. 2, a Class 5 switch 16 is being replaced.

More particularly, with reference back to FIG. 3, a prior routing migration method that is performed on network elements when the Class 4 switch on the network is replaced is depicted. Link 1 represents all PSTN routes to the Class 5 switch 13 (e.g. and end office switch), in this example, with the exception of the Class 4 routes for switches under migration. Link 2 represents the existing route between the Class 4 switch 17 (e.g. a TDM based tandem switch) and the end office 13 on the PSTN 14. This is the Class 4 switch 17 that will be replaced. Link 3 represents the new route between, for example, a TCP/IP Class 4 tandem switch 18 and the end office 13 on the PSTN. This is the replacement Class 4 switch. Link 4 represents a connection to the centralized secure access link 22 for the existing Class 4 switch 17. Link 5 represents a connection to the centralized secure access link 22 for the replacement switch 18. Link 6 represents a connection to the centralized secure access link 22 for the end office 13 on the PSTN 14.

Link 7 represents the communications link for software translation workstation 20-1 that is used to deliver software changes to the end office 12 on the PSTN 13 through link 6. Link 8 represents the communications link for software translation workstation 20-2 that is used to deliver software changes to the existing Class 4 switch through link 4. Link 9 represents the communications link for software translation workstation 20-3 that is used to deliver software changes to the replacement Class 4 switch through link 5. Similar to FIG. 1, reference numeral 11 represents access to facilities that can be rerouted via software changes.

With reference back now to FIG. 4, a configuration incorporating a Routing Migration Broker is depicted. It should be understood that placement of during the Routing Migration Broker 30 occurs during a period when a Class 4 switch is replaced. The Routing Migration Broker 30 only needs to be active in the network during the customer defined transition period. It does not need to be a permanent network element-provisioning vehicle.

Link 1 represents all PSTN routes to the Class 5 switch 13 in this example, with the exception of the Class 4 routes for switches under migration. Link 2 represents the existing route between the Class 4 switch 17 and the end office 13 on the PSTN 14. This is the Class 4 switch that will be replaced. Link 3 represents the new route between the TCP/IP Class 4 switch 18 and the end office 13 on the PSTN 14. This is the replacement Class 4 switch. Link 4 represents a connection to the centralized secure access link 22 for the existing Class 4 switch. Link 5 represents a connection to the centralized secure access link 22 for the replacement switch 18. Link 6 represents a connection to the centralized secure access link 22 for the end office 13 on the PSTN. Link 7 represents the Broker communications link that is used to deliver software changes to the end office 13 on the PSTN 14 through link 6. Link 8′ represents connection to support system database update mechanisms. This link can be informational or a TCP/IP port that can deliver the information through electronic processes such as email or File Transfer Protocol.

The examples of FIGS. 1-4 illustrate a technique for switch replacement between a TDM based switch and an IP based switch. However, it should be understood that the presently described embodiments may be implemented for switch replacements between TDM based switches.

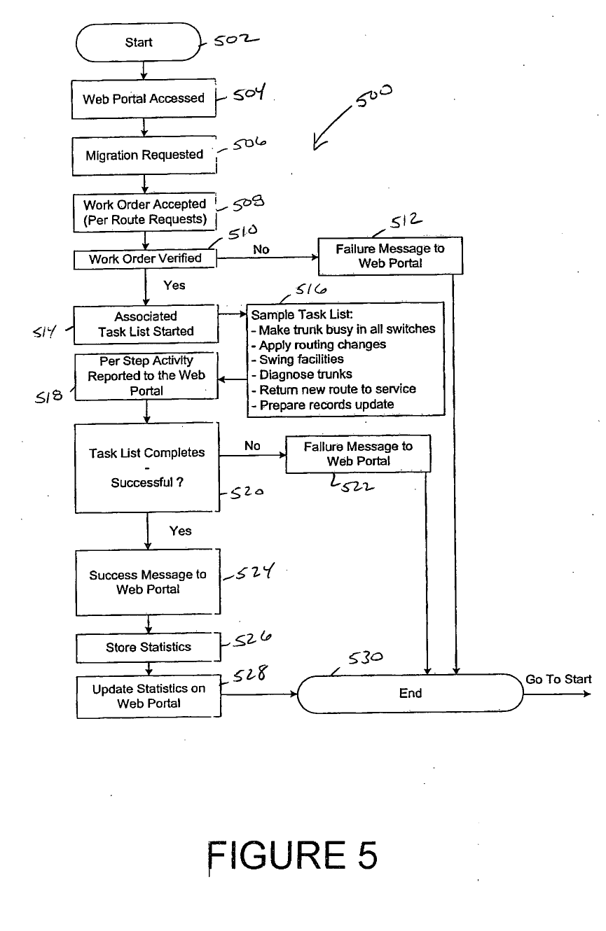

Referring to FIG. 5, a method 500 according to the presently described embodiments is illustrated. It should be appreciated that this method (as well as other contemplated methods of the present invention) may be implemented using a variety of software techniques and hardware configurations. For example, in one form, the software routines that implement the presently described embodiments are maintained on a stand-alone computer device. As another example, the software routines may be somewhat distributed within the network with centralized control remaining with a stand-alone computer device.

As shown in FIG. 5, the method for migration routing is initiated (at 502). Then, the Routing Migration Broker is accessed from a web portal using a web browser on the provisioning TCP/IP network (at 504). The end user requests activation of the software changes by entering the work order number for the re-route (at 506). From this point forward, the Broker mechanizes all processes. Once the work order is received (at 508), it is verified using a previously inserted list of expected requests on the Broker (at 510). If the work order is invalid, the user is notified via a failure message to the web portal (at 512). If the work order is valid, the associated task list is initiated (at 514, 516, 518). The tasks on the task list are prepared and installed on the Routing Migration Broker 30 in advance of the expected work request. An example task list is shown but should not be construed as limiting. If any task on the list fails, the end user is notified via a failure message that is delivered to the web portal (at 518). As changes are successful, the end user is notified via the web portal and statistics are stored (524). Task list completion is also reported to the end user (at 520). Success and/or failure messages are sent (at 522, 524). At task list completion, the current overall project statistics are stored (at 526) and then sent to the web portal as a screen update (at 528). The Broker is now ready for the next routing migration request (at 530).

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A system for controlling routing changes during a switch replacement in a network, the system comprising:
a first switching element;
a second switching element;
a secured access link connected to the first switching element and the second switching element; and,
a routing migration broker connected to the secured access link, the routing migration broker being operative to receive instructions on routing changes, the routing changes implements a replacement of the first switching element by a second switching element, implement the routing changes and reporting a status of the routing changes.

2. The system as set forth in claim 1 wherein the first and second switching elements are of a Class 4 type.

3. The system as set forth in claim 1 wherein the first and second switching elements are of a Class 5 type.

4. The system as set forth in claim 1 wherein the first switching element is a Time Division Multiplexed (TDM) based end office and the second switching element is an Internet Protocol (IP) based end office.

5. The system as set forth in claim 1 wherein the first switching element is a Time Division Multiplexed (TDM) based tandem switch and the second switching element is an Internet Protocol (IP) based tandem switch.

6. The system as set forth in claim 1 wherein the first and second switching element are Time Division Multiplexed (TDM) based switching elements.

7. The system as set forth in claim 1 wherein the migration broker is operative to communicate with the first and second switching elements through the secured access link.

8. A method for route changing during a switch replacement in a network, the method comprising:
receiving a request at a migration broker to migrate routes from a first switching element to a second switching element in the network;
validating the request; and,
implementing routing changes by the migration broker in accordance with the request, the routing changes effecting a replacement of the first switching element by the second switching element.

9. The method as set forth in claim 8 wherein validating the request comprises verifying a work order.

10. The method as set forth in claim 8 wherein the first and second switching elements are of a Class 4 type.

11. The method as set forth in claim 8 wherein the first and second switching elements are of a Class 5 type.

12. The method as set forth in claim 8 wherein the first switching element is a Time Division Multiplexed (TDM) based end office and the second switching element is an Internet Protocol (IP) based end office.

13. The method as set forth in claim 8 wherein the first switching element is a Time Division Multiplexed (TDM) based tandem switch and the second switching element is an Internet Protocol (IP) based tandem switch.

14. The method as set forth in claim 8 wherein the first and second switching elements are Time Division Multiplexed (TDM) based.

15. The method as set forth in claim 8 wherein the migration broker is operative to communicate with the first and second switching elements through the secured access link.

16. A system for route changing during a switch replacement in a network, the system comprising:
means for receiving a request at a migration broker to migrate routes from a first switching element to a second switching element in the network;
means for validating the request; and,
means for implementing routing changes by the migration broker in accordance with the request, the routing changes effecting a replacement of the first switching element by the second switching element.
